(19) United States
(12) Patent Application Publication
(10) Pub. No.: US 2004/0004459 A1
(43) Pub. Date: Jan. 8, 2004

(54) 12-36-Volt automatic-self charging power module

(76) Inventor: Rudolph v. Bailey, Dover, DE (US)

Correspondence Address: Rudolph v. Bailey Sr., D.B.A. JESUS & Bailey Inc., 938 Shank Road, Dover, DE, 19904, US

(21) Appl. No.: 10/191,248

(22) Filed: Jul. 8, 2002

(51) Int. Cl. H02J 7/00

(52) U.S. Cl. 320/107

(57) ABSTRACT

A self-contained DC-self-charging power module of 12 to 36-volts that could be used to power land, marine, and air, crafts and also to build electrical power generators and HV/AC systems is disclosed. These modules could be connected in series and or parallel circuits in order to achieve a desired voltage and amperage, for almost any task.

This can be accomplished by installing batteries in series to give the desired volts and amps. Motor or motors with means to operate a energy re-cycling component to re-charge the batteries, could be installed. A computerized monitoring system could be installed, to control and monitor said power device, so that the batteries are re-charged automatically weather the device is in use or not.

### BACKGROUND

This version of the invention is concerned with the field of self-charging direct current power devises such as batteries; where said power source does not need an external charging source for its continual normal use. This application also covers some of the uses and applications of the said power modules. These uses includes the following: DC-rectifying transformer packages, for building AC-power stations, and DC and AC transforming generators for converting DC-power to AC-power for general use; DC/HVAC systems to help alleviate present power shortages, and save money to consumers; DC-electric cars and trucks, AC-electric bus and DC-electric Air craft, DC-marine craft and DC and AC-trains, also to be used in power plants, and module racks for increasing volts and amps. These power modules will also be used to develop a thermal air pump module, which will be used to propel new land, marine, And aircraft engines. All of these products will save money for consumers, because they will use no fossil fuel.

The present invention will save the environment because there will be no pollution created by said devices. The ecology will also be helped because the present invention would lead to less drilling for oil and oil spills. The present invention will also help to free the nations from dependence on imported oil. The present invention will also help to save lives because automobile and aircraft wrecks will result in fewer fires, caused by gasoline and fuel oil. This is especially important since the tragic events of Sep. 11, 2001. The present invention will also save business from the spiraling cost of fuel and the lack of enough power to operate. The said mentioned products will be explained in continuation, divisional and daughter and granddaughter applications.

### DISCUSSION OF THE PRIOR ART

When batteries are being used as a power source they cannot be relied on for continued use without dependence on a separate charging source. This greatly limits how batteries can be used as a power source, since they must work in conjunction with a separate charging source. To overcome this limitation an attempt has been made to install solar plates inside a flashlight, to charge the batteries automatically. This design is disclosed in U.S. Pat. No. 4,648,013, issued to Raymond f. Curiel on 3 Mar. 1987. This attempt falls short of its intended goal as the above mentioned device depends on the Sun for its recharging power. When the Sun is not shining the charging source cannot be depended on.

As illustrated by background art, efforts are continuously being made in an attempt to develop an internal re-charging mechanism for battery powered devices. No prior effort, however, provides the benefits attendant with the present invention. As such, it may be appreciated that there is a continuing need for a new and improved method to re-cycle the charging energy within battery operated devices, eliminating the need for a separate battery charging system or operation. In these respects, the present version of the invention substantially departs from the conventional concepts and designs of the prior art, and in so doing provides an apparatus that substantially fulfills this need. Additionally, the prior patent and commercial techniques do not suggest the present inventive combination of component elements arraigned and configured as disclosed herein.

The present invention achieves its intended purposes, objects, and advantages through a new, useful and unobvious combination of methods steps and component elements, with the use of a minimum number of functioning parts, at a reasonable cost to manufacture, and by employing only readily available materials.

### SUMMARY

The present version of the invention, which will be described in greater detail hereinafter, relates to the field of continuous DC power devices such as self-charging battery devices. This version of the invention is concerned with devices that are designed to power other devisees without need to re-charge the batteries for normal operation. In some instances the device can also deliver torque which can be used for a verity of uses. My version of the invention overcomes all of the shortcomings listed previously, in addition to novel aspects that will be described in detail hereinafter.

Described briefly, according to a typical embodiment, the invention prevents a self-contained self-charging power module to deliver a steady continuous source of DC power and toque. The said module can be used by its self, or in conjunction with other modules to create the power source needed for various activities. A 36-volt module consist of three 12-volt batteries connected in series. A 24-volt module has two 12-volt, and a 12-volt module has two 6-volt batteries each connected in series to achieve the desired voltage and amperage for that module. Motor or motors are installed in each unit with means to operate a current re-cycling component with volts and amps and sensors enough to refurbish said batteries on a as needed basis. This process eliminates the need for any external energy source for said modules' normal operation. Another version called a torque-box power module can also deliver turning motion along with current. This makes the present invention a more practical energy source than just batteries alone, which must depend on some external charging source for its continued operation. Module racks also can be used to increase volts and amps. A service monitor also controls said modules' operation, and alerts user of potential problems.

My invention, therefore, resides not in any one of these features per se, but rather in the particular combination of all of them herein disclosed. It is distinguished from the prior art in this particular combination of all its structures for the functions specified.

In as much as the forgoing has outlined rather broadly the more pertinent and important features of the present invention in order that the detailed description of the invention that follows may be better understood, so that the present contribution to the art can be more fully appreciated, Additional features of the invention will be described hereinafter. It should be appreciated by those skilled in the art that the conception and the disclosed specific methods and structures may be readily utilized as a basis for modifying or designing other structures for carrying out the same purposes of the present invention. It should be realized by those skilled in the art that such equivalent methods and structures do not depart from the spirit and scope of the invention.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which the disclosure is based is based, may readily be utilized as a basis for designing of other structures, methods and systems for carrying out the several purposes of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application nor is it intended to be limiting as to the scope of the invention in any way.

Accordingly, it is an object of my version of the invention to provide a low-cost, easy-to-manufacture, and easy-to-market self-charging power module.

A further object of my version of the invention is to provide an easy-to-use and versatile power module and torque box.

A significant object of the invention is to provide a self-charging power module and torque box that can be used in a variety of ways, to produce power for land, marine and air crafts, and power generators, and HV/AC systems.

Another important object of the invention is to save money to consumers, and to alleviate air and water pollution caused by the use of fossil fuel, and to deliver the nations from dependence on imported oil.

A final but very significant object of the invention is to provide a self-charging power module that will save lives, as automobile and aircraft wrecks will result in fewer fires due to the fact that said power modules will replace fossil fuel uses.

For a better understanding of the invention, its operating advantages and the specific objects attained by its uses, reference should be made to the accompanying drawings and descriptive matter in which there is illustrated preferred and alternate embodiments of the invention. The foregoing has outlined some of the more pertinent objects of the invention. These objects should be construed to be merely illustrative of some of the more prominent features and applications of the present invention. Many other beneficial results can be attained by applying the disclosed invention in a different manner or by modifying the disclosed invention within the scope of the disclosure. Accordingly, other objects and a fuller understanding of the invention may be had by referring to the summary of the invention and the detailed description of the preferred and alternate embodiments in addition to the scope of the invention illustrated by the accompanying drawings.

### BRIEF DESCRIPTION OF THE DRAWINGS

The foregoing and other objects, features, and advantages of the inventions will become more fully understood from the following description of the preferred and alternate embodiments of the invention as illustrated in the accompanying drawings, in which reference characters refer to the same parts throughout different views. The drawings are not necessarily to scale, emphasis is instead being placed upon illustrating the principles of the invention.

FIG. 1 is a plan view of a 36-volt power module; also showing future service monitor, and remote voice communicator/controller and remote volt/amp meter and anunciator/beeper.

FIG. 2 is an elevational view of a module rack showing front and rear elevations, and illustrating a 216-volt and a 440-amp wiring configuration, also a 216-volt and 220-amp wiring configuration.

FIG. 3 is an elevational view of a module rack showing front and rear elevations, and illustrating a 432-volt and a 220-amp wiring configuration, also illustrating a 108-volt and 220-amp configuration.

FIG. 4 is an elevational view of a 432-volt and a 440-amp module rack showing front and rear elevations, and a 432-volt and a 440-amp wiring configuration.

FIG. 5 is a perspective view of a 24-volt 62-amp torque-box power module alternate embodiment in accordance with the present version of the invention.

FIG. 5A is a perspective view of a wiring configuration for a 24-volt and 100-amp power module in accordance with the present version of the invention.

### DESCRIPTION OF THE PREFERRED EMBODIMENT

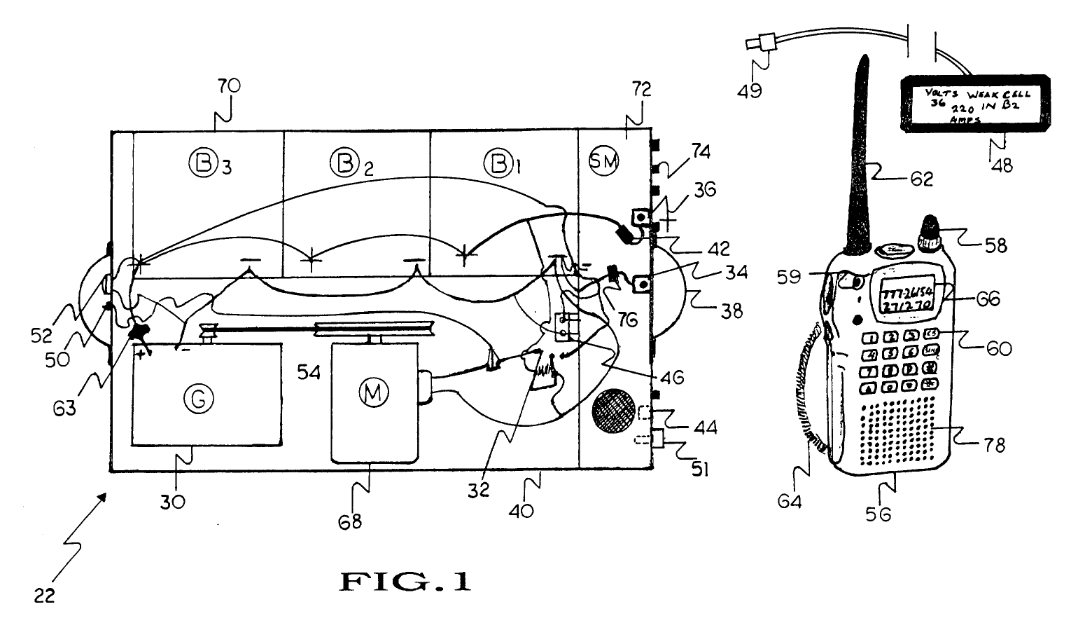

Description Referring now to the drawings and, in particular to FIG. 1 wherein there is illustrated a typical embodiment of a 36-volt automatic-self-charging-power module 22. The present version of the invention 22 is constructed of materials and components that are light weight and durable, and resistant to corrosion and oxidation, such as plastic, aluminum, carbon steel, various composite materials or a combination thereof: including the possibilities of conductive polymers.

The device 22 consists in a main housing 40 of the following: three batteries 70, a motor and pulley assembly 68, a generator assembly 30, a motor drive belt 54, a sensor switch 32, a test push button 50, a volt meter 52, a remote on/off sensor switch 76, a fuse 42, terminals 34 & 36, a voltage regulator 63, two carrying handles 38, a future service monitor 72, a service monitor battery charger connection 46, a remote voice communicator/controller 56, and a remote annunciator/beeper 48.

Referring again to FIG. 1, batteries 70 are connected in series, to give 36-volts. Motor assembly 68, and generator assembly 30 are positioned with drive belt 54, in such a way that when powered by sensor switch 32, when there is a 1-volt drop in device 22, the batteries 70 are refurbished by generator 30(generator 30 is a 38-volt motor operated counter-clockwise by motor 68). When 38-volts are reached in device 22, sensor switch 32 opens the circuit to motor 68, thereby stopping the charging process. This cycle is repeated on a as needed basis, weather the device 22 is in use or not. Thereby eliminating the need for any external energy source to keep the device 22 in operation.

Referring again to FIG. 1 service monitor(SM) 72 has its own 36-volt internal battery which is re-charged via connection 46. The voltage in power module(PM) 22 is controlled by voltage regulator 63. Unit SM. 72 monitors the condition of PM 22 and alerts the operator of any potential or immediate problems. This information is conveyed either by voice prompts or numerically. Said messages can be heard over speaker 98, or by remote voice communicator. controller (RVCC) 56. RVCC 56 can also work as a cellular phone or two-way radio controlled by button 60. RVCC 56 is battery operated, and is re-charged through cord 64, by standard 12-volt battery charger. RVCC 56 can also be used to turn PM 22 on or off, through sensor switch 76 by pressing button 59.

Continuing with FIG. 1 remote annunciator/beeper(RA) 48, can display messages transmitted by SM. 72, a beep alerts user to a new message. RA 48 can also be connected to SM. 72 by plug 49 and receptor 51.

### Description of Module Racks

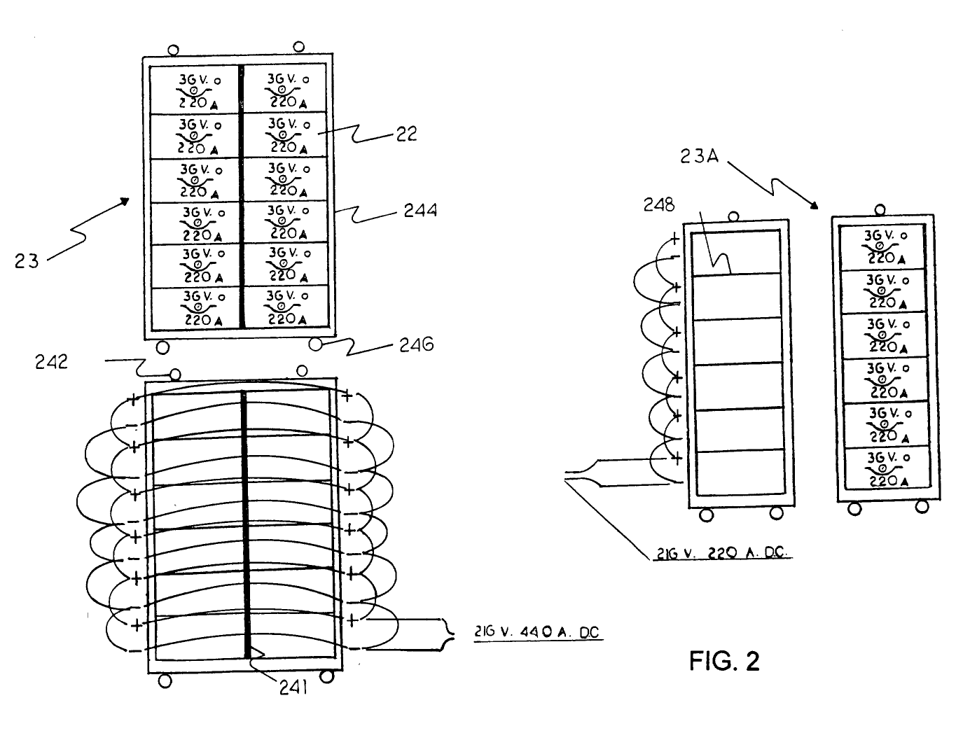

Referring now to FIG. 2 wherein there is illustrated a typical embodiment of power module racks 23 and 23A. The present version of the invention is constructed of mild steel or aluminum depending on its' use. The device 23 consist of main outer frame 244, with intermediate shelves 248 sturdy enough to support the weight of said power modules. Some units are constructed with center support 241 to support shelves on either side of outer frame 244. The device 23 is equip with a set of lifting lugs 242, and wheels 246. Also illustrated by FIG. 2 is a proposed wiring configuration for a 216-volt and 440-amp module rack 23, and a 216-volts and 220-amps DC module rack 23A.

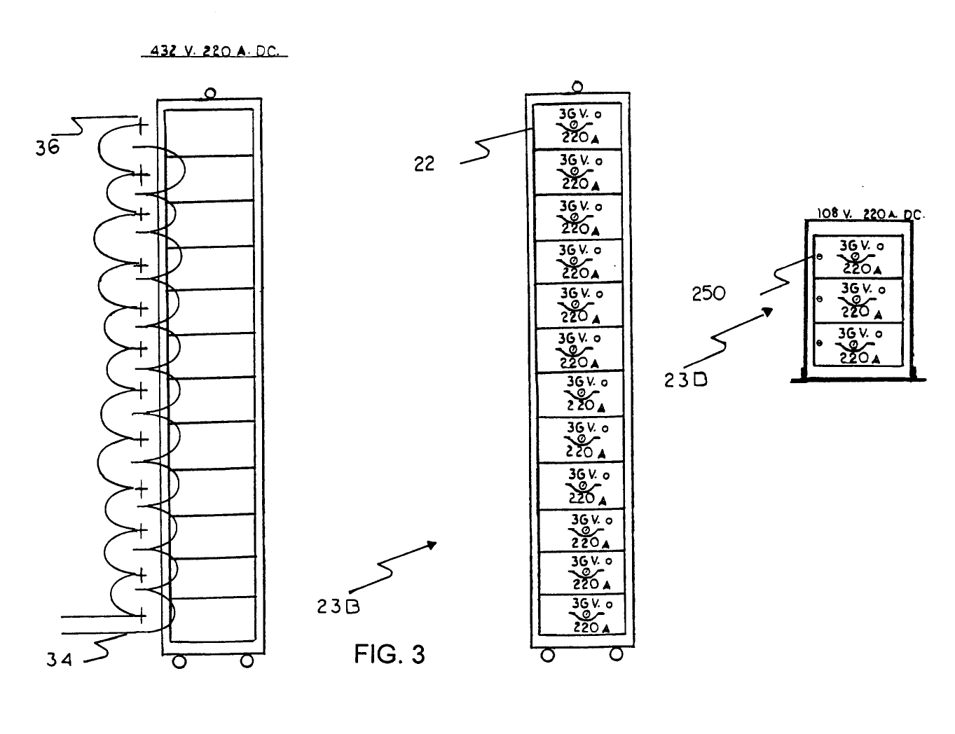

FIG. 3 illustrates a typical embodiment of a module rack 23B, and 23D showing proposed wiring configuration for a 432-volt and 220-amps, and a 108-volt and 220-amps DC module rack respectively.

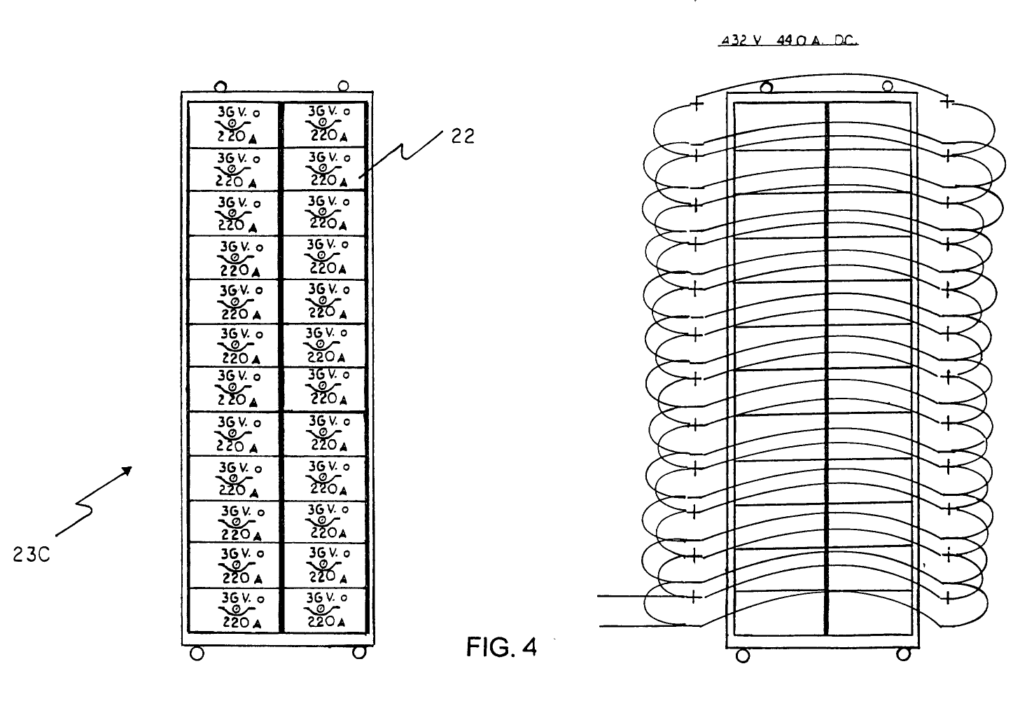

FIG. 4 illustrates a typical embodiment of a module rack 23C showing proposed wiring configuration for a 432-volt and 440-amps DC module rack.

Description of Alternate Embodiment

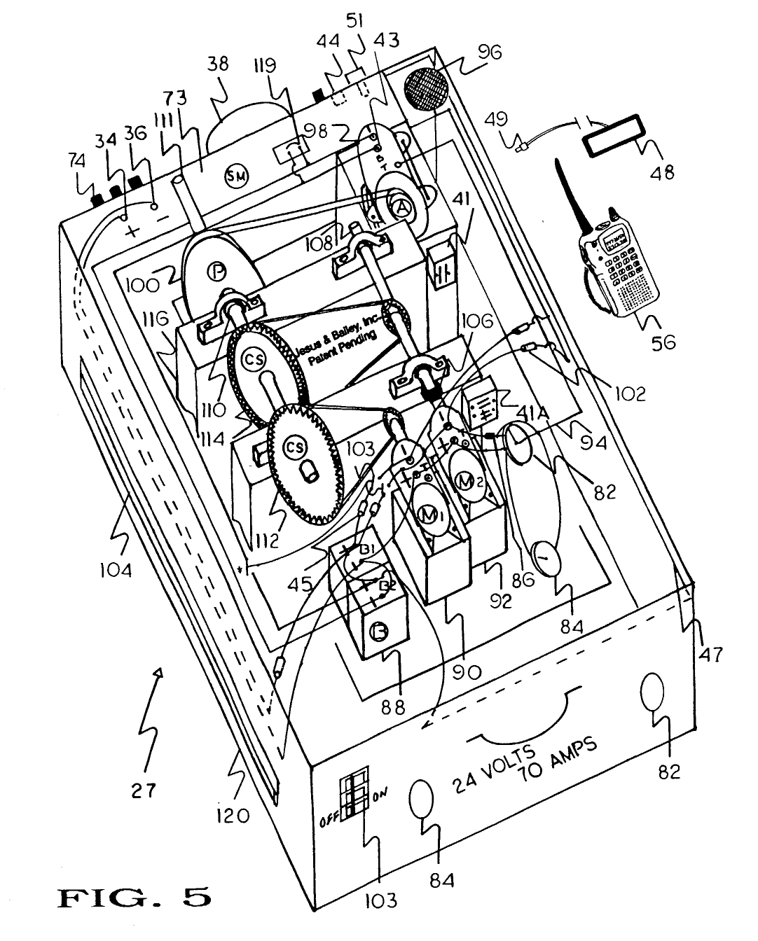

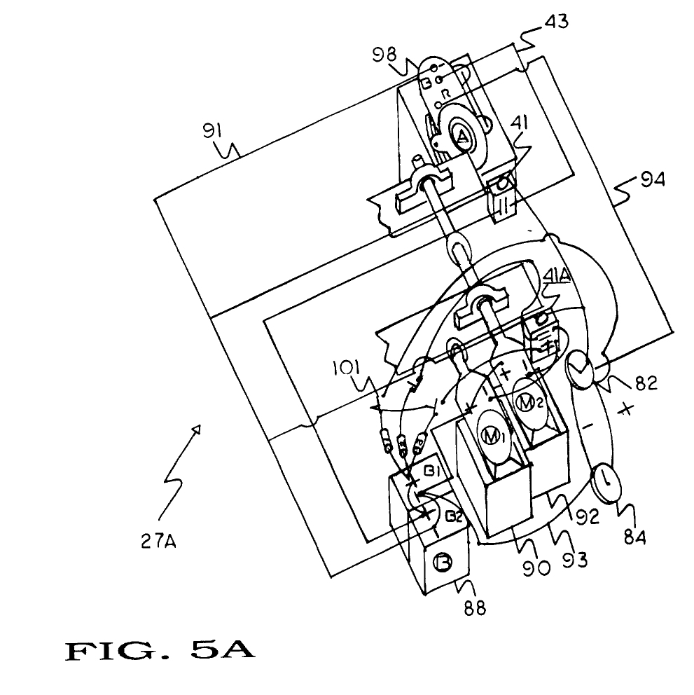

Referring again to the drawings and in particular to FIG. 5 wherein there is illustrated an alternate embodiment of a 24-volt torque-box power module 27. The present version of the invention 27, is constructed of materials and components that are light weight, durable and resistant to corrosion and oxidation such as plastic, malleable iron, wood, carbon steel, composite materials, or a combination thereof: including the possibilities of conductive polymers. The device 27 consist in a main housing 120 of the following major parts: Two 1 HP motors (M1) 90 and (M2) 92, two 12-volt batteries(B1 & B2) 88, two chain & sprocket drive assembly 112(12 to 1 ratio) and 114(7 to 1ratio), and two bearing and drive shaft assembly 108 main and 110 auxiliary, and two relays 41 & 41A, one volt meter 84, and one tachometer speed switch 82, and one 150-amp-24-volt alternator 98, and alternator drive pulley 100, and service monitor 72, and on/off switch 103, and torque drive extension shaft 111.

When switch 103 is closed power goes to motors M1 and M2, instrument gauges 82 and 84 and alternator 98. This action permits alternator 98 to re-furbish battery 88, in response to internal voltage regulator of alternator 98. The said process will allow torque-box power module 27 to operate perpetually. When switch 103 is in the off position service monitor(SM.) 73 monitors the condition of torque-box power module(TPM) 27. When there is a drop in voltage SM. 73 transmits a signal to motors 90 & 92 via wires 102. When the desired voltage and current is achieved SM. 73 turns said motors off, thereby keeping said batteries continuously re-furbished, weather said module is in use or not.

Extension torque drive-shaft 111 can be extended outside housing 120, and used for desired turning motion. In addition to that 62-amps will be available from terminals 34 & 36.

Description of Alternate Wiring

Referring now to FIG. 5A wherein there is illustrated a wiring configuration for a 24-volt-100-amp power module 27A. This version of the invention 27A only allows one motor to operate at a time; therefore the amperage at terminals 34 and 36 (FIG. 5) will be higher than the TPM 27. Power module(PM) 27A cannot be operated as a torque-box. This version of the invention 27A is designed for DC power only, although PM 27A has all the components of the TPM 27, and functions under the same principle.

Referring again to FIG. 5A when switch 101 is closed, motor 90 is energized, and instrument gauges 82 and 84 receives power. Alternator 98 is set in motion (see FIG. 5). Alternator 98 has an internal tachometer that operate in concert with tachometer speed switch 82. When the set speed is satisfied on tachometer speed switch 82 (see FIG. 5A), power goes to relay coils 41 and 41A. This said action transfers power to motor 92, and stops motor 90. Power also is transmitted to alternator 98, thereby allowing the charging process to begin. A 12-volt module would operate under any of the previously mentioned principles.

Ramifications

The amperage and voltage specified in the present application of the invention are merely for exemplification and should not be considered to be limitations upon the scope of the invention in any way. Accordingly all suitable volts and amps may be resorted to. The specifications of motor ratings speed ratios, charging components and such like, should not be construed to be limitations upon the present invention; Therefore all other equivalent or suitable components, or rating, may be resorted to without departing from the spirit and scope of the invention.

Conclusion and Scope of Invention

From the foregoing, it will be understood by persons skilled in the art that an improved DC power device has been provided. The invention is relatively simple and easy to manufacture, yet affords a variety of uses. While my description contains many specifications, these should not be construed as limitations on the scope of the version of the invention but rather as an exemplification of the preferred embodiment thereof. The foregoing is considered as illustrative only of the principles of the invention. Further, since numerous modifications and changes will readily occur to those skilled in the art, it is not to be sired to limit the invention to the exact construction and operation shown and described, accordingly all suitable modifications and equivalents may be resorted to, falling within the scope of the invention.

Although this invention has been described in its preferred form with a certain degree of particularity, it is to be understood that the present disclosure of the preferred form has been made only by way of example, and numerous changes in details of construction and combination, and arrangements of parts may be resorted to without departing from the spirit and scope of the invention.

Drawing Reference Numbers

30 38-volt generator

32 Sensor on/off switch

34 Negative terminal connection

36 positive terminal connection

38 Carrying handle

40 Module housing

41 24-volt tachometer relay

41A 24-volt tachometer relay

42 Main module fuse

43 Re-cycle charging wire

44 External speaker connection

45 Motor fuse

46 SM battery charger connection

47 Positive lead wire to SM

48 Remote annunciator/beeper(RA)

49 RA connector to SM

50 Voltage test push button

51 RA receptacle

52 Volt meter for PM 22

54 Generator drive-pulley belt

56 Remote voice communicator/controller(RVCC)

58 RVCC on/off switch

59 Remote on/off switch

60 Two-way radio control

62 Antenna for RVCC

63 Voltage regulator

64 RVCC battery charger connection

66 RVCC display screen

68 36-volt drive motor & pulley assembly

70 12-volt re-chargeable batteries(B1,B2,B3)

72 Service monitor with 36 to 12-volt internal battery charger

73 Service monitor with 24 to 12-volt internal battery charger

76 RVCC speaker

82 24-volt tachometer

84 24-volt, volt-meter

86 Instrument fuse

88 12-volt re-chargeable batteries(B1,B2)

90 24-volt motor(M1)

91 Negative lead re-cycle wire

92 24-volt motor(M2)

93 Negative lead to instrument gauges

94 Tachometer sensor wire

96 Service monitor speaker

98 24-volt alternator

100 Alternator drive pulley

101 Double throw switch

102 Motor power lead from SM 73

103 Triple throw switch

104 Air vent louvers

106 Motor coupler

108 Main drive shaft assembly

110 Auxiliary drive shaft assembly

111 Extension torque drive shaft

112 Chain & sprocket assembly(12-1)

114 Chain & sprocket assembly(7-1)

116 Bridge supports for pillow blocks

119 SM 73 charger wire connection

120 Module housing without cover

241 Center support

242 Lifting lugs

244 Outer frame

246 Wheels

248 Shelf

250 Module lock

1. What I claim is the independent means to create DC power and torque perpetually within a device without need for any external energy source for normal operation comprising:
(a) DC motor or motors with means to increase torque and
(b) additional drive shaft with means to operate charging component and desired moving part simultaneously and
(c) charging component with controls and volts & amps enough to charge
(d) battery or batteries of volts & amps enough to operate said motor or motors and desired parts and
(e) computerized monitoring system to control and monitor said power device whereby said charging component re-cycles charging energy to said batteries as said parts are appropriately interconnected in appropriate casing thereby creating continuous power.

2. What I claim is the independent means to create 12 to 36-volts of steady continuous DC power without need for any external energy source for normal operation comprising:
(a) sensors switches and gauges to show output energy and control on/off operation with
(b) motor assembly having means to operate
(c) charging component with controls having means to refurbish
(d) battery or batteries which are connected in series to give desired volts and amps and
(e) computerized monitoring system to control and monitor said power device whereby said charging component re-charges said batteries weather said module is in use or not as said parts are appropriately interconnected in appropriate casing.
